(19) United States
(12) Patent Application Publication
(10) Pub. No.: US 2018/0137491 A1
(43) Pub. Date: May 17, 2018

(54) HOST DEVICES WITH E-PAPER DISPLAYS

(71) Applicant: HEWLETT-PACKARD DEVELOPMENT COMPANY, L.P., HOUSTON, TX (US)

(72) Inventors: AARON SANDERS, (US); AARON MATTHEW SANDERS, HOUSTON, TX (US)

(21) Appl. No.: 15/563,302

(22) PCT Filed: Jul. 30, 2015
(86) PCT No.: PCT/US2015/042853

§ 371 Date: Sep. 29, 2017

(51) Int. Cl. G06Q 20/20; G06F 3/147

(52) U.S. Cl. CPC G06Q 20/20; G06F 3/041; G06F 3/147; G06Q 20/209

(57) ABSTRACT

In an example implementation, a point of sale (POS) system includes a host device having a merchant-facing touch-screen display to enable a merchant to conduct a payment transaction at a point of sale. The POS system also includes a customer-facing e-paper display integrated with the host device to display details of the transaction to a customer.

### BACKGROUND

Point of sale (POS) systems are utilized in many different industries, ranging from retail environments and restaurants, to hotels and hospitality businesses. POS systems can be used where ever goods or services can be exchanged for monetary value. The phrase point of sale, generally refers to the retail store or location where such sales transactions occur However, it can also refer to the equipment or devices used to facilitate such transactions, which can include various hardware and software components. Early 20^{th} century POS systems included mechanical cash registers operated by a lever or crank. Technology has advanced POS systems well beyond the early mechanical cash registers of the past.

### BRIEF DESCRIPTION OF THE DRAWINGS

Examples will now be described with reference to the accompanying drawings, in which:

FIG. 1 shows an example of point of sale (POS) system suitable for implementing an e-paper customer-facing display (CFD);

FIG. 2 shows an example of a POS system in which an e-paper CFD is integrated with a host device being implemented as a tablet computer;

FIG. 3 shows an example of a POS system in which an e-paper CFD is integrated with a stand for a host device;

FIG. 4 shows an example of a POS system in which art e-paper CFD is integrated with a pole display stand; and

FIGS. 5 and 6 show flow diagrams that illustrate example methods of conducting a point of sale system transaction.

Throughout the drawings, identical reference numbers designate similar, but not necessarily identical, elements.

### DETAILED DESCRIPTION

As noted above, point of sale (POS) systems include various hardware and software components that facilitate sales transactions. These components can include a variety of peripheral devices, such as cash drawers, touch-screen displays, barcode scanners, magnetic stripe readers, receipt printers, weighing scales, line displays, and pole displays. UPOS (Unified POS) is an open standards initiative that provides software application interfaces (APIs) for use with many of these POS peripheral devices. These software API's provide standardized connectivity between POS peripheral devices, which allows for greater freedom of choice for retailers by enabling them to select the POS peripheral devices that are best suited to their particular retail environments.

One peripheral device often included in retail and other POS systems is a customer-facing display (CFD). Retailers use the CFD to show customers the price for each item, along with an updated total purchase cost in real time, as the items are being scanned through the system. Many countries require retailers to use CFD's for retail point of sale transactions. In addition, CFD's are required by law in various states throughout the United States.

While most CFD's are comprised of a two-line display that displays item prices and a total cost, other CFD's can incorporate the use of larger LCD's (liquid crystal displays) or other types of video displays. CFD's often implement vacuum florescent displays (VFD) or light emitting diode (LED) displays, in addition to using a USB (universal serial bus) to serial conversion for communication. However, CFD's implemented with such technologies are large and expensive, and can consume a great deal of power.

Accordingly, example point of sale (POS) systems described herein incorporate robust, inexpensive, efficient, and highly effective customer-facing displays (CFD's) that serve as an ideal replacement for the types of two-line displays noted above. To this end, example POS systems include CFD's comprising electronic-paper (e-paper) as the customer-facing display mechanism. It is to be noted that the term e-paper, s used herein, and as generally understood with regard to electronic display technologies, is intended as a generic term that encompasses display technologies that function based on reflected light, take very little or no power to maintain a static image, and resemble real paper in terms of contrast, thickness, flexibility, and readability in sunlight. Thus, e-paper is intended as a collective name for the various e-paper and e-ink products currently available and that might be developed in the future. Some example implementations of e-paper include electronic billboards, mobile phone displays, and e-readers that display digital versions of books and e-paper magazines. E-paper is also ideal for use as a two-line CFD because it is energy efficient, has a thin/small profile, can be viewed in direct sunlight, and supports a wide viewing-angle. E-paper uses power to change images, but not to hold the image that is displayed, making it energy efficient and ideal for applications that hold images for a long period of time. An e-paper CFD can be used in conjunction with a controller and software such as UPOS software API's that enable it to operate within existing POS systems in a “plug-and-play” manner, but at a lower cost and with all of the advantages of e-paper.

In different examples, e-paper CFD's can be integrated into existing POS system components. For instance, an e-paper CFD can be incorporated directly into the case or jacket covering on the back side of a mobile POS host device (e.g., tablet computer). This manner of integrating an e-paper CFD enables customers to view details of a sales transaction while a merchant performs the transaction using the merchant-facing touch-screen on the front side of the host device. Similarly, an c-paper CFD can be integrated into the back side of a support stand of a POS host device, or incorporated onto a pole display. In different examples, an e-paper CFD includes a wireless radio for wireless communication with the host device to update the display during a sales transaction or to display other advertisements or messages. Is some examples, an e-paper CFD includes a rechargeable battery with wireless charging coils to recharge the battery. In some examples an e-paper CFD can be connected via USB which can enable the exchange of data between the CFD and host device, as well as provide power and/or energy to recharge the CFD battery.

In one example implementation, a point of sale (POS) system includes a host device having a merchant-facing touch-screen display. The merchant-facing touch-screen display enables a merchant to conduct a payment transaction at a point of sale, such as a waiter taking a dinner order from customers at a table in a restaurant. The POS system also includes a customer-facing e-paper display integrated with, the host device to display details of the transaction to a customer. The customer-facing e-paper display can be integrated, for example, into the back cover of the host device or a carrying jacket/case of the host device, to enable carrying the host device while permitting continual merchant access to the merchant-facing touch-screen while customers can view details of the transaction in real time as the merchant conducts the transaction.

In another example implementation, a point of sale system includes a host device such as a tablet computer to conduct POS transactions. The POS system includes a stand to support and detachably secure the host device. The POS system also includes a customer-facing e-paper display that is integrated into the back side of the stand and is wirelessly coupled to the host device to receive and display information about the POS transactions. In another example, the stand comprises a pole stand, and the customer-facing e-paper display is integrated on the pole stand.

In another example implementation, a method of conducting a point of sale transaction includes receiving sales transaction input at a host device through a merchant-facing touch-screen. The method also includes displaying details of the sales transaction on an e-paper customer-facing display, where the merchant-facing touch-screen and the e-paper customer-facing display are directed in opposite directions.

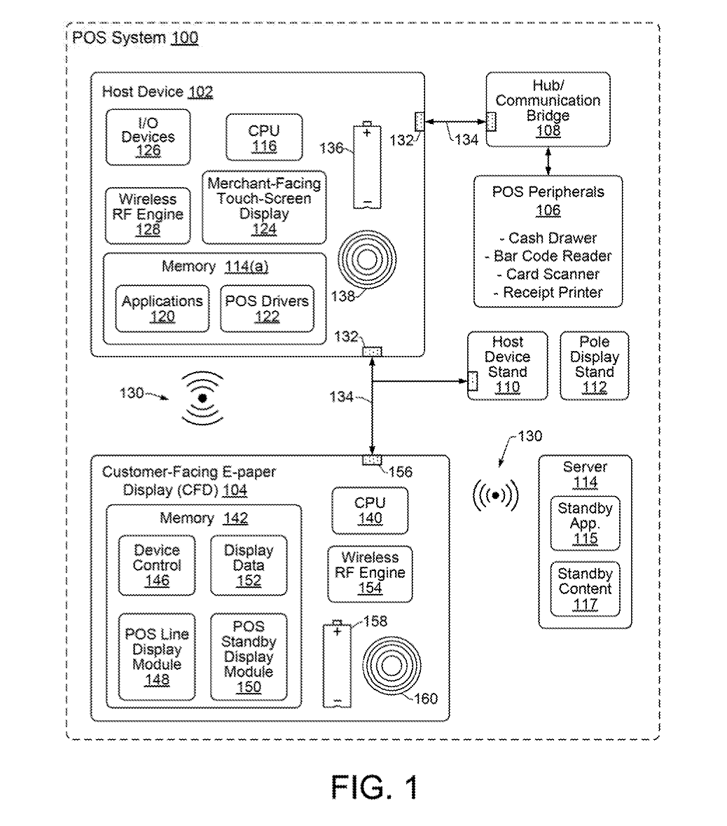

FIG. 1 illustrates an example of point of sale (POS) system 100 suitable for implementing an e-paper customer-facing display (CFD). The example POS system 100 includes, a host device 102 and an e-paper CFD 104, In some examples, the POS system 100 may include additional POS peripheral, devices 106. POS peripheral devices 106 can include, but are not limited to, devices such as a cash drawer, a bar code reader a card scanner (e.g., a magnetic stripe reader), and a receipt printer. The POS system 100 may also include a hub 108 or communication bridge 108 to connect the host device 102 with the peripheral devices 106. A server 114 may be part of a POS system 100 to provide, for example, messages and/or advertisements generated by a standby application to be displayed on the e-paper CFD 104.

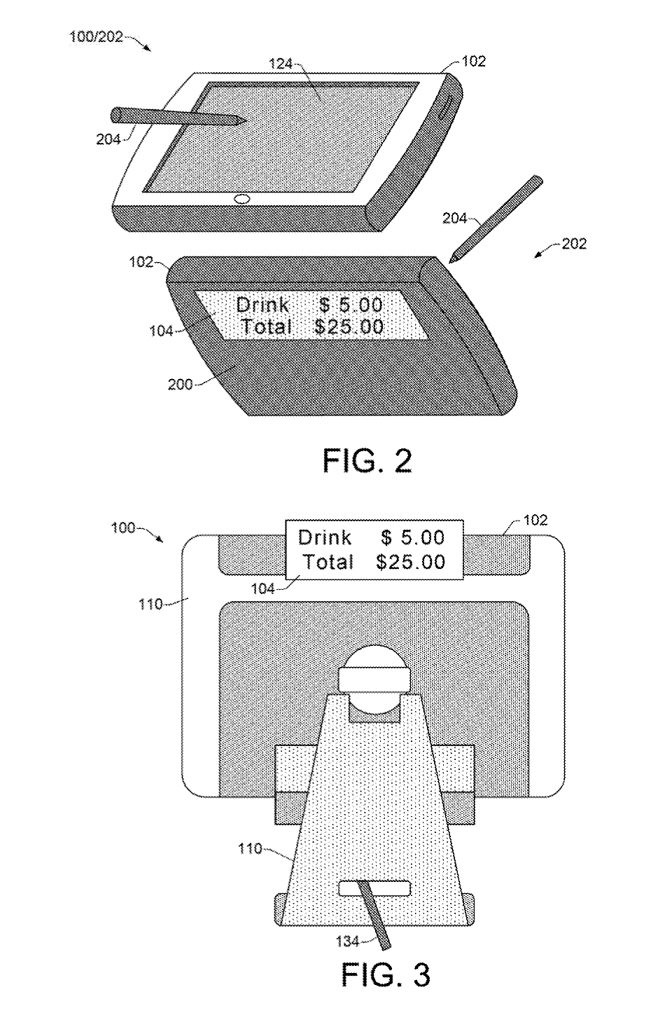

The host device 102 comprises a computer such as a tablet computer 102 (FIG. 2). While the host device 102 is discussed herein as comprising a tablet computer, there is no intent to limit the host device in this respect. Thus, in some examples, a host device may be implemented as other devices such as a smart phone, a personal digital assistant (PDA), a notebook computer, and/or other mobile and stationary electronic computing devices.

As shown in FIG, 1, the host device 102 includes one or multiple processors (CPU) 116 and a memory 118. The components of memory 118 comprise non-transitory, machine-readable (e.g., computer/processor-readable) media that provide for the storage of machine-readable coded program instructions, data structures, program instruction modules, and other data for the host device 102, such as applications 120 and POS drivers 122. The program instructions, data structures, and modules stored in memory 118 may be part of an installation package that can be executed by a processor (CPU) 116 to implement various functions. For example, the processor 116 of host device 102 can execute instructions from POS drivers 122 that can conduct payment transactions, provide information regarding payment transactions to the e-paper CFD 104 and the server 114, and so on. Thus, memory 118 may be a portable medium such as a CD, DVD, or flash drive, or a memory maintained by a server from which the installation package can be downloaded and installed. In another example, the program instructions, data structures, and modules stored in memory 118 may be part of an application or applications already installed, in which case memory 118 may include integrated memory such as a hard drive. In some examples, the host device 102 may additionally include an application specific integrated circuit (ASIC) and/or other hardware and firmware (not shown) having instructions executable on an ASIC and/or processor 116 to perform to various functions of a POS system 100.

Host device 102 includes a merchant-facing touch-screen display 124, as well as other input/output (I/O) devices 126, such as a speaker, a microphone, a camera, and so on. In some examples, host device 102 includes a wireless radio, illustrated as wireless radio frequency (RF) engine 128. Host device 102 may incorporate multiple types of wireless RF engines 110 to enable communication over a variety of wireless radio communication protocols. A wireless RF engine 128 generally comprises different hardware components such as an integrated circuit (IC) chip set and software components that implement a set of standards to establish radio communication 130 between devices when the devices are brought within a certain range or proximity to one another. In general, the type of wireless protocol implemented by a wireless RF engine 128 on the host device 102 enables short-range wireless communications between devices, such as the host device 102, the e-paper CFD 104 and the server 114. Suitable wireless radio communication protocols that can be implemented by a wireless RF engine 128 include, for example, Bluetooth Bluetooth LE (low energy), Wi-Fi, Zigbee, iBeacon, Global System for Mobile Communications (GSM), and near field communication (NFC).

The host device 102 additionally includes a physical interface 132 for electronic communication and/or for receiving power. An example of a physical interface 132 includes a universal serial bus (USB) connector to receive a USB cable 134, or some other proprietary connector to receive a different cable. While the host device 102 can run directly off of power through a physical interface 132, the physical interface 132 can also be used to recharge a rechargeable battery 136. In some examples, the host device 102 incorporates a receiver coil 138 that enables wireless charging of the rechargeable battery 136. Wireless charging of the host battery 136 can be done, for example, by placing the host device 102 on a wireless charging platform (not shown). A wireless charging platform can incorporate a transmitting coil that generates a magnetic field as it circulates alternating current. While the host device 102 rests in the charging platform, the magnetic field can extend to the receiver coil 138, where it generates current within the receiver coil 136. The current in the receiver coil 138 can charge the battery 136 of the host device 102.

As noted, the example POS system 100 of FIG. 1 also includes an e-paper CFD 104. The example e-paper CFD 104 is an “intelligent” device that has computing capability. Thus, the e-paper CFD 104 includes a processor (CPU) 140 and a memory 142. The memory 142 comprises non-transitory, machine-readable (e.g., computer/processor-readable) media that provides for the storage of machine-readable coded program instructions, program instruction modules and, data for the host device 102, such as device control module 146, POS line display module 148, POS standby display module 150 and data 152 from the host device 102 to be displayed. The program instructions, data structures, and modules stored in memory 142 may be part of an installation package that can be executed by processor (CPU) 116 to implement various display-related functions.

For example, while sales/payment transactions are being conducted on the POS system 100, the e-paper CFD 104 can operate in a transaction mode where the processor 140 can execute instructions from the device control module 146 to receive transaction display data 152 from the host device 102 (e.g., data from POS driver 122), send receipt acknowledgements to the host device 102 and so on. In a transaction mode, the POS line display module 148 is generally executable on processor 140 to manipulate and parse information from the display data 152 to generate lines of textual information for display on the e-paper display.

The POS standby display module 150 can execute to put the e-paper CFD 104 in a standby mode in different circumstances, such as while there are no sales/payment transactions being conducted, or while the POS system 100 is in a standby mode. For example, the e-paper CFD 104 can be placed in a standby mode through a command from the host device 102, or it may place itself in a standby mode when it is disconnected from communication with the host device 102. In a standby mode, the POS standby display module 150 switches the e-paper CFD 104 communication to the standby application 115 on server 114. In the standby mode the POS standby display module 150 executes to receive and parse standby content 117 from the server standby application 115, and display the standby content 117 on the e-paper CFD 104. The standby content 117 can include, for example, non-transactional advertising information and messaging information, such as a message from a merchant indicating a time of return. When the e-paper CFD 104 returns to the transaction mode from the standby mode, for example, when it receives a command or other communication from the host device 102, it returns to displaying sales/payment transactional display data 152 received from the host device 102.

The e-paper CFD 104 includes a wireless radio, illustrated as wireless radio frequency (RE) engine 154. The e-paper CFD 104 may incorporate multiple types of wireless RE engines 154 to enable communication over a variety of wireless radio communication protocols. A wireless RE engine 154 generally comprises different hardware components such as an integrated circuit (IC) chip set and software components that implement a set of standards to establish radio communication 130 between devices when the devices are brought within a certain range or proximity to one another. In general, the type of wireless protocol implemented by a wireless RE engine 154 on the e-paper CFD 104 enables short-range wireless communications between devices, such as between the host device 102, the e-paper CFD 104, and the server 114. Suitable wireless radio communication protocols that can be implemented by a wireless RE engine 154 include, for example, Bluetooth, Bluetooth LE (low energy), Wi-Fi, Zigbee, iBeacon, and NFC.

In some examples, the e-paper CFD 104 can also include a physical interface 156 for electronic communication and/or for receiving power. One example of a physical interface 156 is a USB connector to receive a USB cable 134. While the e-paper CFD 104 can run directly off of power through a physical interface 156, the physical interface 156 can also be used to recharge a rechargeable battery 158 on the e-paper CFD 104. In some examples, the e-paper CFD 104 also incorporates a receiver coil 160 that enables wireless charging of the rechargeable battery 158. Wireless charging of the battery 158 can be done, for example, in a similar manner as discussed above with regard to the host device 102, by placing the -paper CFD 104 on a wireless charging platform.

FIG. 2 shows an example of a POS system 100 in which an e-paper CFD 104 is integrated with a host device 102 being implemented as a tablet computer 102. In this example, the e-paper CFD 104 is integrated onto or into the back cover 200 or housing of the tablet computer 102. This configuration enables the tablet computer 102 and e-paper CFD 104 to become a mobile POS terminal 202 through which a merchant can conduct payment transactions at the immediate point of sale. In some examples, the e-paper CFD 104 can be integrated into a jacket or carrying case being used to carry the tablet computer 102. Example point of sale settings for such a mobile POS terminal 202 include restaurant environments in which waiters and waitresses travel throughout a restaurant taking customer orders. As a waiter takes the customer order and conducts the payment transaction using the merchant-facing touch-screen display 124, which may include the use of a stylus 204, the customer can follow the transaction in real time by viewing the e-paper CFD 104. The e-paper CFD 104 can display, for example, the price of each item as it is ordered and entered into the tablet>computer 102 by the waiter, and a running total amount due for payment on the transaction. Conducting the sales transaction on such a mobile POS terminal 202 informs the customer immediately as to the extent of the dining tab, which can facilitate a fast and convenient payment before, during or after a meal, without the customer having to experience the delay in flagging down the waiter and then waiting while the waiter retrieves the bill.

FIG. 3 shows an example of a POS system 100 in which an e-paper CFD 104 is integrated with a stand 110 for a host device 102. In this example, the host device 102 is implemented as a tablet computer 102. As shown in FIG. 3, instead of being integrated into or onto the tablet computer 102 itself, the e-paper CFD 104 is integrated onto the back of the tablet stand 110. The stand 110 supports the tablet computer 102, and the tablet computer 102 can be attached and detached from the stand 110. The stand 110 is a component of a POS system 100 as illustrated in FIG. 1, and it can be positioned directly in front of a customer, such as in a checkout line of a retail store. Having the e-paper CFD 104 integrated onto the back side of the stand 110 therefore positions the e-paper CFD 104 conveniently within the view of a customer while a merchant conducts a sales transaction using the merchant-facing touch-screen display 124 of the tablet computer 102 and other POS peripheral devices 106, such as a bar code reader. In this example, the tablet computer 102 can be coupled to POS peripheral devices 106 wirelessly or through a USB or other cable 134, which may include connections through a hub 108 (FIG. 1).

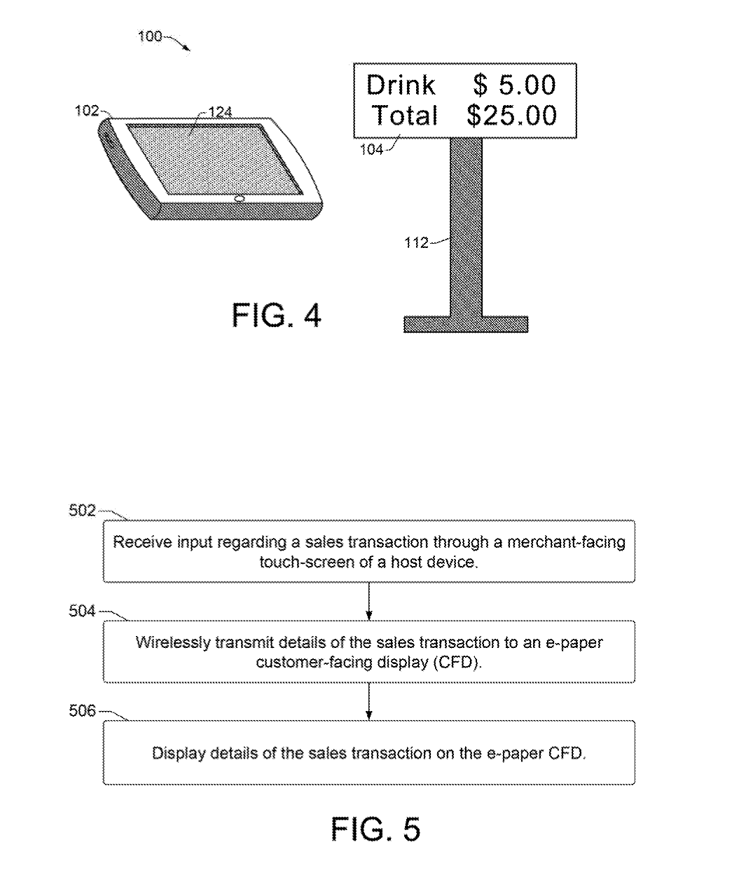

FIG. 4 shows an example of, a POS system 100 in which an e-paper CFD 104 is integrated with a pole display stand 112 As with previous examples, the e-paper CFD 104 on the pole display stand 112 can communicate wirelessly with a host device 102 to receive and display POS sales transaction information, advertising and other messaging information.

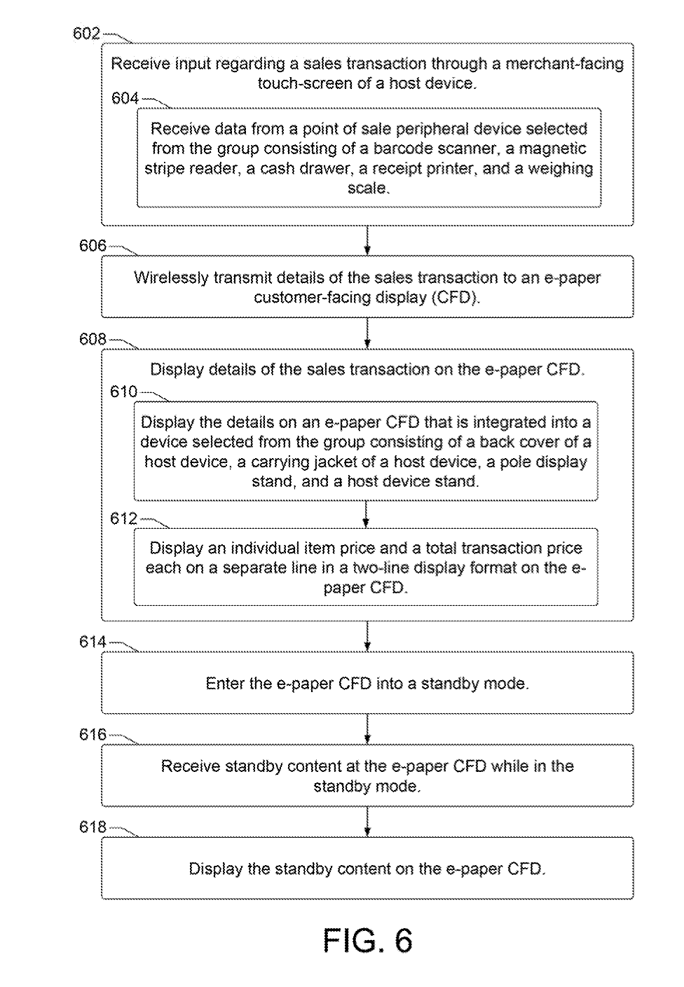

FIGS. 5 and 6 show flow diagrams that illustrate example methods 500 and 600, respectively, of conducting a point of sale system transaction. Methods 500 and 600 are associated with examples discussed above with regard to FIGS. 1-4, and details of the operations shown in methods 500 and 600 can be found in the related discussion of such examples. The operations of methods 500 and 600 may be embodied as programming instructions stored on a non-transitory, machine-readable (e.g., computer/processor-readable) medium, such as memory 118 and memory 142 shown in FIG. 1. In some examples. implementing the operations of methods 500 and 600 can be achieved by a processor, such as processor 116 and processor 140 of FIG. 1, by reading and executing the programming instructions stored in a memories 118 and 142, respectively. In some examples, implementing the operations of methods 500 and 600 can he achieved using an ASIC (not shown) and/or other hardware components alone or in combination with programming instructions executable by a processor 116 and 140.

The methods 500 and 600 may include more than one implementation, and different implementations of methods 500 and 600 may not employ every operation presented in the flow diagrams of FIGS. 5 and 6. Therefore, while the operations of methods 500 and 600 are presented in a particular order within the flow diagrams, the order of their presentation is not intended to be a limitation as to the order in which the operations may actually be implemented, or as to whether all of the operations may be implemented. For example, one implementation of method 600 might be achieved through the performance of a number of initial operations without performing some of the subsequent operations, while another implementation of method 600 might be achieved through the performance of all of the operations.

Referring now to the flow diagram of FIG. 5, an example method 500 of conducting a point of sale system transaction begins at block 502, with receiving input regarding a sales transaction through a merchant-facing touch-screen of a host device. The method continues at block 504 with wirelessly transmitting details of the sales transaction to an e-paper customer-facing display (CFD). As shown at block 506, the method then includes displaying details of the sales transaction on the e-paper CFD.

Referring now to the flow di a of FIG. 6, an example method 600 of conducting a point of sale system transaction begins at block 602 with receiving input regarding a sales transaction through a merchant-facing touch-screen of a host device. As shown at block 604, in some examples of method 600, receiving input regarding a sales transaction can include receiving data from a point of sale peripheral device selected from the group consisting of a barcode scanner, a magnetic stripe reader, a cash drawer, a receipt printer, and a weighing scale. The method 600 continues at block 606 with wirelessly transmitting details of the sales transaction to an e-paper customer-facing display (CFD). Then, as shown at block 608, details of the sales transaction can be displayed on the e-paper CFD. As shown at block 610 in some examples of method 600, displaying details of the sales transaction can include displaying the details on an e-paper CFD that is integrated into a device selected from the group consisting of a back cover of a host device, a caning jacket of a host device a pole display stand, and a host device stand. As shown at block 612, displaying details of the sales transaction can also include displaying an individual item price and a total transaction price, each on a separate line in a two-line display format on the e-paper CFD.

As shown at block 614, the method 600 can include entering the e-paper CFD into a standby mode. While in the standby mode, the e-paper CFD can receive standby content, as shown at block 616. The e-paper CFD can ten display the standby content, as shown at block 618.

What is claimed is:

1. A point of sale (POS) system comprising:
a host device having a merchant-facing touch-scree display to enable a merchant to conduct a payment transaction at a point of sale;
a customer-facing e-paper display integrated with the host device to display details of the transaction to a customer.

2. A POS system as in claim 1, wherein the host device comprises:
a back cover to enclose a back side of the host device; and,
wherein the e-paper display is integrated into the back cover of the host device.

3. A POS system as in claim 1, further comprising;
a carrying jacket to carry the host device while permitting continual merchant access to the merchant-facing touch-screen;
wherein the e-paper display is integrated into the carrying jacket at a back side of the host device.

4. A POS system as in claim 1, wherein the e-paper display comprises a wireless RF engine to implement a wireless communication protocol with the host device.

5. A POS system as in claim 4, wherein the wireless communication protocol is selected from the group consisting of Bluetooth LE (low energy), Bluetooth. ZigBee, iBeacon, Global System for Mobile Communications, and near field communication.

6. A POS system as in claim 1, wherein the e-paper display comprises:
a rechargeable e-paper battery; and
a charging coil to charge the e-paper battery when the charging coil is brought within proximity of a transmitting coil.

7. A POS system as in claim 6, wherein the host device comprises:
a host charging coil to charge a rechargeable host battery when the host charging coil is brought within proximity of the transmitting coil, such that the e-paper battery and the host battery can charge simultaneously from the same transmitting coil.

8. A point of sale (POS) system comprising:
a host device to conduct POS transactions;
a stand to support and detachably secure the host device; and
a customer-facing e-paper display integrated into a back side of the stand and wirelessly coupled to the host device to receive and display information about the POS transactions.

9. A POS system as in claim 8, wherein the information about the POS transactions comprises an individual item price and a total transaction price, and wherein the customer-facing e-paper display displays the individual item price and the total transaction price each on a separate line in a two-line display format.

10. A POS system as in claim 8, wherein the stand comprises a pole stand, and the customer-facing e-paper display is integrated onto the pole stand.

11. A non-transitory machine-readable storage medium storing instructions for conducting a point of sale system transaction, the instructions that when executed by a processor of a system, cause the system to:
receive input regarding a sales transaction through a merchant-facing touch-screen of a host device;
wirelessly transmit details of the sales transaction to an e-paper customer-facing display (CFD); and
display details of the sales transaction on the e-paper CFD.

12. A storage medium s in claim 11, the instructions further causing the system to:
enter the e-paper CFD into a standby mode;
receive standby content at the e-paper CFD while in the standby mode; and
display the standby content on the e-paper CFD.

13. A storage medium as in claim 11, wherein to receive input regarding a sales transaction comprises receiving data from a point of sale peripheral device selected from the group consisting of a barcode scanner, a magnetic stripe reader, a cash drawer, a receipt printer, and a weighing scale.

14. A storage medium as in claim 11, wherein to display details of the sales transaction comprises displaying the details on an e-paper CFD that is integrated into a device selected from the group consisting of a back cover of a host device, a carrying jacket of a host device, a pole display stand, and a host device stand.

15. A storage medium as in claim 11, wherein to display details of the sales transaction comprises displaying an individual item price and a total transaction price each on a separate line in a two-line display format on the e-paper CFD.
